(19) United States
(12) Patent Application Publication
(10) Pub. No.: US 2013/0282736 A1
(43) Pub. Date: Oct. 24, 2013

(54) SYSTEMS AND METHODS FOR ACTIVITY BASED CONNECTIONS

(71) Applicants: Kate Baldoni, Newport Beach, CA (US); Jillian Garton, Granite Bay, CA (US)

(72) Inventors: Kate Baldoni, Newport Beach, CA (US); Jillian Garton, Granite Bay, CA (US)

(21) Appl. No.: 13/453,757

(22) Filed: Apr. 23, 2012

(51) Int. Cl. G06F 17/30

(52) U.S. Cl. 707/749; 707/736; 707/748; 707/E17.058

(57) ABSTRACT

The systems and methods described herein relate to making activity based connections. In an example embodiment a web based system can connect people together based on one or more items on an activity list such as a “bucket list.” For example, by collecting an activity list from a first user including at least one activity, collecting an activity list from a second user including at least one activity, analyzing the activity list of the first and second users to determine if the activities are the same or similar, and matching the first user to the second user based on the activity list of each user.

### FIELD OF THE INVENTION

Embodiments of the invention relate to systems and methods for activity based connections. More particularly, some embodiments relate to social networks.

### BACKGROUND OF THE INVENTION

In the 2007 film, “The Bucket List” the movie follows two terminally ill men on a journey attempting to complete a list of things to do before they “kick the bucket,” i.e. die. The two men have almost nothing in common (aside from terminal illness), but meet while sharing a room in the hospital. Like the main characters, many people may have a “bucket list” of things they want to do. This can be true for people that are terminally ill as well as people that are healthy. These various people may want to do these activities in their life time, before they graduate, before hitting a certain age, as part of a birthday celebration when they reach that age, or at any number of other points in their life.

It can, however, be difficult to plan for accomplishment of one or more items on a person's bucket list, however. For example, it may be difficult or impossible to find people interested in doing a particular activity or taking a particular trip on one's bucket list because people you already know may not have the same bucket list or may not have a bucket list at all.

Traditional social networks do not provide features tailored to planning and executing such activities. For example, while FACEBOOK® has a “group” feature, the group feature on FACEBOOK® is only for pre-existing friends. While it may seem that one would simply be able to complete bucket list activities with immediate friends or through some sort of social networking site like FACEBOOK®, it will actually be difficult to organize and find a group. Often times none of your immediate friends will want to do the same crazy activity as you, and social networking sites involve networks that have already achieved some sort of closure. FACEBOOK® is for social activity among cliques of friends.

Various search engines allow users to search for the companies that can fulfill their bucket list goals. Many of the search engines allow users to provide feedback options once users search on their website, but not every option relates to the topic requested. Search engines only provide information on an activity. They do not allow you to set up a group to join you on the activity. (To the extent the search engine companies provide email, groups, etc., they still do not provide for connection between people based on bucket list items.) Other social networking sites may have many similar features to FACEBOOK®. Some focuses mainly on different groups interactions. None of these web sites provides an integrated set of features that will allow users to efficiently plan and execute items on their bucket list.

GROUPON® aggregates people together into groups in order to purchase products and services at a cheaper price. These people may or may not know each other. Additionally, even if they know each other, they will not know they are in the same GROUPON® group unless they happen to discuss the good or service with each other or happen to meet each other when completing the purchase of the good or service. In other words, people may use GROUPON® to save on goods and services that they might plan together in a conventional way, but this web site also does not provide an integrated set of features that will allow users to efficiently plan and execute items on their bucket list.

### SUMMARY OF THE INVENTION

Various embodiments of the systems and methods described herein relate to systems and methods for activity based connections. More particularly, some embodiments relate to social networks. Some embodiments include a processor and a memory coupled to the processor storing instructions. These instructions can cause the processor to implement methods in accordance with the systems and methods described herein.

To this end, an exemplary embodiment is a web based system that can connect people together based on one or more items on an activity list such as a “bucket list.”

In an exemplary embodiment the present invention, a computer program product comprising: a non-transitory computer readable medium including instructions causing a computer to perform the following steps: collecting an activity list from a first user including at least one activity; collecting an activity list from a second user including at least one activity; analyzing the activity lists of the first and second users to determine if the activities are the same or similar; and matching the first user to the second user based on the activity list of each user.

In an exemplary embodiment, wherein the first user's activity list includes a plurality of activities and the second user's activity list includes a plurality of activities.

In an exemplary embodiment, further comprising instructions implementing a ranking of users based on the number activity list items that match.

In an exemplary embodiment, further comprising instructions implementing a ranking of users based on the similarity of activity list items.

In an exemplary embodiment, further comprising instructions implementing a ranking of users based on a combination the number of similar bucket list items and how similar the activity list items are.

In an exemplary embodiment, further comprising instructions implementing a live chat between matched users.

In an exemplary embodiment, further comprising instructions implementing a user's feedback system to provide feedback on other users or service providers.

In an exemplary embodiment, further comprising instructions causing the computer to perform the following steps: collecting input from users reviewing companies that provide a good or service; and providing those reviews to users who input the same or a similar activity.

In an exemplary embodiment, further comprising instructions implementing a search filter to limit search results to a group having a preselected characteristic.

In an exemplary embodiment, wherein the computer program implements a system for matching users over the Internet.

In an exemplary embodiment the present invention, a system comprising: a processor; a memory, coupled to the processor, the memory including instructions causing the processor to: collect an activity list from a first user including at least one activity; collect an activity list from a second user including at least one activity; analyze the activity lists of the first and second users to determine if the activities are the same or similar; and match the first user to the second user based on the activity list of each user.

In an exemplary embodiment, wherein the first user's activity list includes a plurality of activities and the second user's activity list includes a plurality of activities.

In an exemplary embodiment, further comprising instructions implementing a ranking of users based on the number of activity list items that match.

In an exemplary embodiment, further comprising instructions implementing a ranking of users based on the similarity of activity list items.

In an exemplary embodiment, further comprising instructions implementing a ranking of users based on a combination of the number of similar bucket list items and how similar the activity list items are.

In an exemplary embodiment, further comprising instructions implementing a live chat between matched users.

In an exemplary embodiment, further comprising instructions implementing a user's feedback system to provide feedback on other users or service providers.

In an exemplary embodiment, further comprising instructions causing the computer to perform the following steps: collecting input from users reviewing companies that provide a good or service; and providing those reviews to users who input the same or a similar activity.

In an exemplary embodiment, further comprising instructions implementing a search filter to limit search results to a group having a preselected characteristic.

In an exemplary embodiment, wherein the system is implemented over the Internet.

An exemplary embodiment provides a website that enables users to connected with other users having one or more activities on an activities list (i.e., “bucket list”) that are the same or similar. Generally, a “bucket list” is a list of activities that one hopes to accomplish before they die. As used herein, however, the term “bucket list” is used more broadly to include any lists of activities that one or more persons wish to complete. In some cases it will include once in a lifetime experiences.

An exemplary embodiment provides a website having features which will facilitate the planning of desired events. People might make a bucket list that they plan to do, but actually executing and planning the activities is easier said than done. Laziness and complications with planning often prevent people from completing their bucket lists. This website will provide solutions to these problems by making planning easier for our users as well as forming groups to make prices cheaper and experiences more enjoyable.

An exemplary embodiment provides a social networking site with features tailored to completing a list of activities, trips, or tasks. An embodiment may connect users after analyzing their bucket lists rather than reconnecting preconceived friendships. (It will be understood, however, that preexisting friends might be connected when they have one or more of the same or similar items on their bucket lists.)

An exemplary embodiment provides a search option that allows users to connect based on having one or more bucket list items that are the same or similar. An example embodiment may rank users based on the number of bucket list items that are the same or similar. Another example embodiment may rank users based on the similarity of bucket list items. A combination of similarity and number of similar bucket list items may also be used.

An exemplary embodiment provides a search filter which will help avoid problems that might occur based upon age, gender, location, and education. For example, if someone only wants to be with 20-30 year old females that went to Stanford and live in their area, then they can.

An exemplary embodiment provides a live chat. The chat component will allow the user to establish a personal connection with individuals in their chosen group. Developments of weak ties will be made in this step to enhance group cohesiveness and with one's network. After a group is formed, our users are all planning on spending at least a weekend together, so it is helpful for them to get to know each other beforehand. The chat function will be designed to facilitate this vital step.

An exemplary embodiment provides users to select “thumbs up” (good) or “thumbs down” (bad). For example a thumbs up button and a thumbs down button (e.g. virtual buttons on a web site) may be used. Such buttons might be used to rate people that you have previously done activities with, service providers that have provided activities, or other aspects of services provided for an activity. For example, if you “thumbs up” someone, then you can in turn, be connected and see whom that person has also “thumbs up” which can extend your network even further. By pushing the “thumbs down” button, it will prevent you from being linked or connected with that person again.

An exemplary embodiment provides recommendations for planning options. For example, after the user chooses their group for an activity, an embodiment provides a website that will rank the cheapest airline, hotel (if needed), and company that will help them achieve their goal. If a user has, for example, selected “thumbs down” for a particular airline, that airline might be flagged to remind the user of the low rating or omitted from the list entirely. Some embodiments may use a metric to determine if a “thumbs down” provider is included. For example, the provider that had previously received the “thumbs down” rating might be shown only when it is the lowest price, the lowest 3 prices, within a certain percentage of the lowest price, etc.

An exemplary embodiment provides recommendations to make the site useful to users by providing them with reviews that they do not have to search out on their own. The features of an embodiment may make everything easier for the user. An exemplary embodiment provides trip planning that can be fun and interactive and allows users to connect with other people with similar interests.

An exemplary embodiment provides the opportunity to expand social networks and create many new ties, rather than just focusing on current ties. Limiting to only known people can make it difficult to find people to do a bucket list activity or take a bucket list trip. Previously known people in a closed network may not want to participate.

An exemplary embodiment allows users to participate in a crazy activity with other individuals who are similar to them and potentially at similar points in their lives.

An exemplary embodiment allows for the ability to compare different companies for goods and services related to a bucket list item. Comparisons may be quickly compiled for a large number of bucket list items (generally the entire bucket list.) This frees a user from having to search for information on each bucket list item one item at a time.

An exemplary embodiment allows for linking together similar individuals and allows them to accomplish their dreams. Some embodiments provide for long-term customers based on the number of items on a person's bucket list and how long it may take to complete the items.

An exemplary embodiment may focus on specific age groups. One example embodiment may focus on groups not as ingrained in social networking sites, e.g., 50-60 year olds. People that do not typically use social networking sites may be more likely to use a site with a targeted function to fulfill their bucket list. Another exemplary embodiment may focus on 18-30 year olds. Other exemplary embodiments may focus on other age groups such as 16-17 year olds, 40-50 year olds, and people over 60, etc. Some embodiments may include features that are focused on high school students or college students that might wish to do certain things before graduation.

An exemplary embodiment may allow a large number of different age groups, including allowing persons of any age to use the site. (In some cases parents may plan activities for young children or sites may be limited to adults only. Many variations are possible.)

### BRIEF DESCRIPTION OF THE DRAWINGS

FIG. 1 is a flowchart depicting an example method in accordance with the systems and methods described herein.

FIG. 2 is a flowchart depicting an example method in accordance with the systems and methods described herein.

FIG. 3 is a diagram illustrating an example system in accordance with the systems and methods described herein.

### DETAILED DESCRIPTION OF THE PREFERRED EMBODIMENT

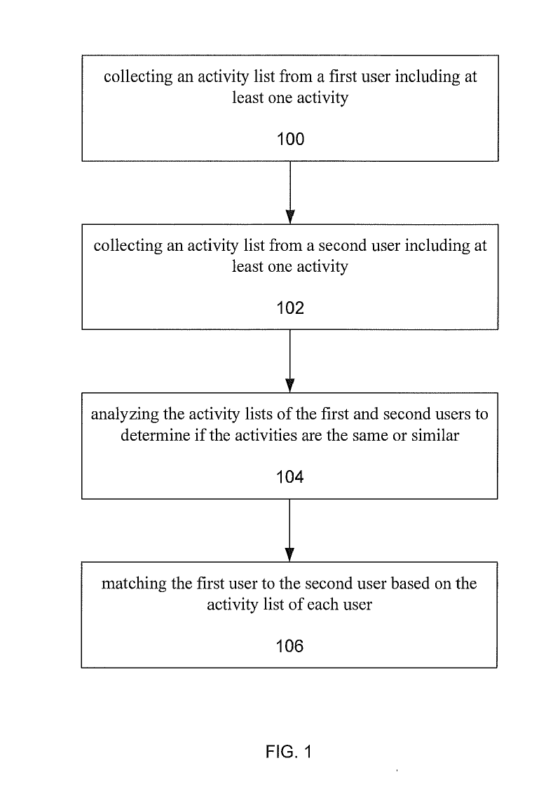

FIG. 1 is a flowchart depicting an example method in accordance with the systems and methods described herein. In step 100 of the example method an activity list is collected from a first user. The activity list includes at least one activity, but can include many activities. The activity list may be a “bucket list,” such as an activity the user wishes do accomplish before some milestone, e.g., graduation, milestone birthdays, within one's lifetime, etc.

In step 102 of the example method an activity list is collected from a second user. Again, the activity list includes at least one activity, but can include many activities. In some example embodiments, the steps may be implemented in a web based system that can connect people together based on the one or more items on each person's activity, e.g. “bucket list.”

In step 104 of the example method the activity list of the first and second users are analyzed to determine if the activities are the same or similar. In step 106 the first user is matched to the second user based on the activity list of each user. It will be understood that the systems and methods described herein may include a large number of users and that generally only a subset of those users will be matched together. For example, many users may not share the same or similar items on the activity lists.

An embodiment may implement a search filter to limit search results to a group having a preselected characteristic. In this way users may filter other users out of a search using a search filter. For example, an exemplary embodiment provides a search filter which will help avoid problems that might occur based upon age, gender, location, and education. For example, if someone only wants to be with 20-30 year old females that went to Stanford and live in their area, then they can.

Other filtering is also possible, for example, users may provide feedback on other users. In an exemplary embodiment users may select “thumbs up” (good) or “thumbs down” (bad). For example a thumbs up button and a thumbs down button (e.g. virtual buttons on a web site) may be used. Such buttons might be used to rate people that you have previously done activities with, service providers that have provided activities, or other aspects of services provided for an activity. For example, if you “thumbs up” someone, then you can in turn, be connected and see whom that person has also “thumbs up” which can extend your network even further. By pushing the “thumbs down” button, it will prevent you from being linked or connected with that person again.

Users may also provide feedback on service providers. In an exemplary embodiment users may select “thumbs up” (good) or “thumbs down” (bad) when rating service providers. For example a thumbs up button and a thumbs down button (e.g. virtual buttons on a web site) may be used. Such buttons might be used to rate service providers that have provided activities, or other aspects of services provided for an activity. By pushing the “thumbs down” button, it will prevent you from being linked or connected with that service provider again.

An exemplary embodiment provides recommendations for planning options. For example, after the user chooses their group for an activity, an embodiment provides a website that will rank the cheapest airline, hotel (if needed), and company that will help them achieve their goal. If a user has, for example, selected “thumbs down” for a particular airline, that airline might be flagged to remind the user of the low rating or omitted from the list entirely. Some embodiments may use a metric to determine if a “thumbs down” provider is included. For example, the provider that had previously received the “thumbs down” rating might be shown only when it is the lowest price, the lowest three prices, within a certain percentage of the lowest price, etc.

It will be understood that other ranking systems might be used rather than “thumbs up”/“thumbs down,” however. For example, people or service providers might be ranked on a 1-5 scale or a 1-10 scale, or some other scale. Additionally, the people or service providers might be ranked with respect to certain aspects. For example, after experiencing an activity with someone a person might be willing to take a day trip with that person, but may have had an experience that makes them unwilling to travel on an overnight trip with that person.

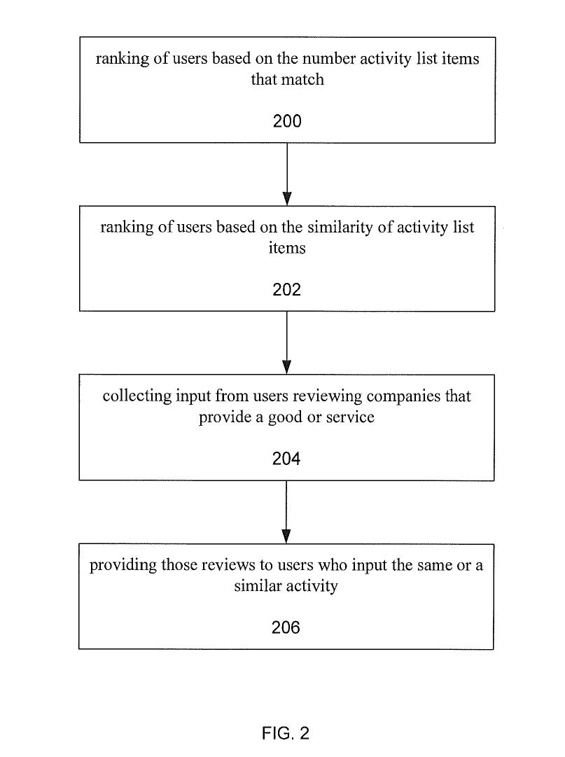

FIG. 2 is a flowchart depicting an example method in accordance with the systems and methods described herein. In many cases the first user's activity list includes a plurality of activities and the second user's activity list includes a plurality of activities and a system implementing this method can then rank users based on compatibility of the users' activities lists.

In step 200 a ranking is performed based on the number of activity list items that match. In step 202 a ranking is performed based on the similarity of activity list items. It will be understood that a combination of number of similar activities and how similar those activities are may also be used to implement a ranking. Ranking the users can allow for a selection of which group of users should be grouped together. In some cases groups of only two people might be created. In other cases, three, four, or even much larger groups can be created.

Group size may be dictated by the activity. For example, if the activity is sky diving, the number of people grouped together might be based on the number of people that can fit into a typical airplane used for sky diving or the specific size of the airplane used at a specific sky diving location. Alternatively, the number of people grouped together might be based on the size of the classroom where ground instruction is given prior to going skydiving.

The example embodiment illustrated in FIG. 2 further includes step 204, collecting input from users reviewing companies that provide a good or service. If reviews from other users are collected then they can be provided to other users in step 206. For example, the reviews might be provided to users who input the same or a similar activity. This can allow users to have a better overall experience because they may be more aware of what to expect or may avoid providers that do not provide the level of service that they are looking for.

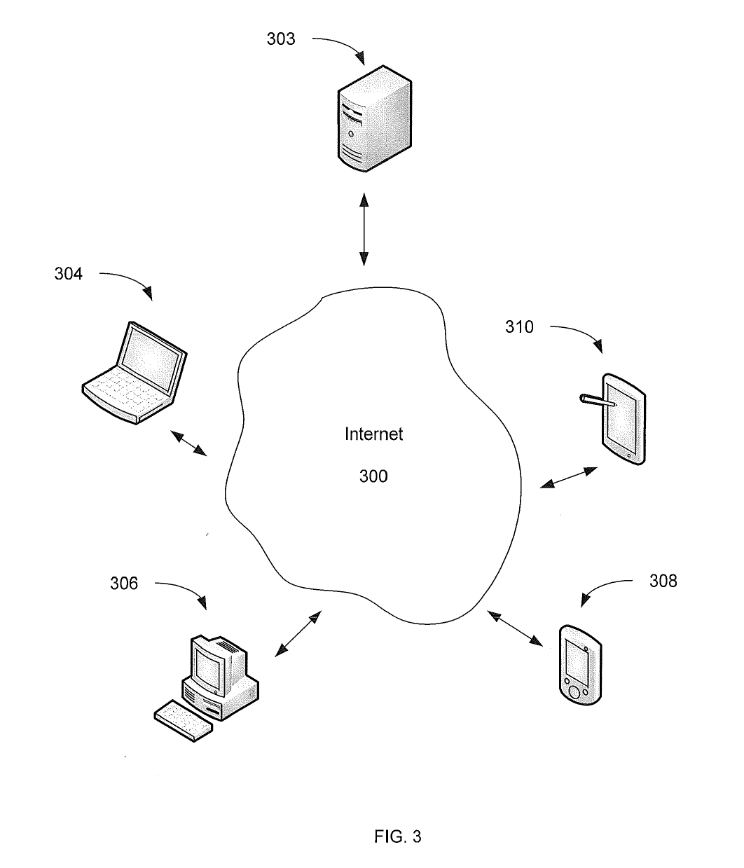

FIG. 3 is a diagram illustrating an example system in accordance with the systems and methods described herein. In the illustrated example, a communication channel 200 such as the Internet may be used. It will be understood that other communication channels may be used. For example, the systems and methods described herein might be implemented using many mobile communication devices such as mobile telephone handsets. These handsets might communicate with each other and a server implementing the system using a mobile telephone network.

Returning to the example system of FIG. 3, a server 303 can be used to perform one or more of the functions described herein. This server 303 may connect to users over the internet 300. The users may access the server over the Internet 300 using a variety of different electronic devices. These devices include, but are not limited to a laptop computer 304; a desktop computer 306; a mobile electronic device 308, such as a personal digital assistant (PDA), smart phone, or other hand held mobile electronic device; and a tablet computer 310. Using such devices 304, 306, 308, 310, a user may provide inputs to the server 303 such as activity lists and the server 303 may provide a list of other users with the same or similar items on their activity lists as well as the other features described herein.

In other embodiments, the Internet 300 could be wired or wireless and might include satellite communications, landline telephone communication, microwave, cellular communication systems, or any other electronic communication system. The Internet 300 can be a collection of individual communications networks, transmission systems, relay stations, tributary stations, and data terminal equipment (DTE) usually capable of interconnection and interoperation to form an integrated whole.

In another embodiment, the Internet 300 could be an optical communication system. Such a system is any form of telecommunication that uses light as the transmission medium. One example includes fiber-optic communication systems that transmits information from one place to another by sending light through an optical fiber.

In another embodiment, the Internet 300 could be a radio communication system. Such a system may be composed of several communication subsystems that give exterior communication capabilities and can include a transmitting conductor in which electrical oscillations or currents are produced and which is arranged to cause such currents or oscillations to be propagated through the free space medium from one point to another remote locator therefrom and a receiving conductor at such distant point adapted to be excited by the oscillations or currents propagated from the transmitter.

In another embodiment, the Internet 300 could be a power line communication system that operates by impressing a modulated carrier signal on power wires. Different types of power line communications use different frequency bands, depending on the signal transmission characteristics of the power wiring used. Combinations of these communication systems might also be used in other embodiments to implement the Internet 300.

The illustrated embodiment includes server 303. It will be understood, however, that in other embodiments, the systems and methods described herein might be implemented by distributing the functionality across the user devices such as 304, 306, 308, and 310. In yet another embodiment the server functionality might be delegated to one or more user devices 304, 306, 308, and 310.

The illustrated embodiment includes multiple types of user devices 304, 306, 308, and 310. It will be understood that some systems might function using a single type of user device. For example, in another embodiment, a number of mobile electronic device 308 might be used. These mobile electronic device 308 might communicate using the mobile electronic devices' communication network, e.g., cellular or other mobile device communication networks. In such a system a server might be connected to the mobile communication network or the mobile devices might provide the functionality.

An exemplary embodiment of the system of FIG. 3 provides a live chat. The chat component will allow the user to establish a personal connection with individuals in their chosen group. Developments of weak ties will be made in this step to enhance group cohesiveness and one's network. After a group is formed, our users are all planning on spending at least a weekend together, it is helpful for them to get to know each other beforehand. The chat function will be designed to facilitate this vital step.

Various examples of the systems and methods described herein provide a website that enables users to connect with other users having one or more activities on an activities list (a bucket list) that are the same or similar. The website may also include features which will facilitate the planning of desired events. An exemplary embodiment provides a social networking site with features tailored to completing lists of activities, trips, or tasks. An embodiment may connect users after analyzing their bucket lists rather than reconnecting preconceived friendships. It will be understood, however, that preexisting friends might be connected when they have one or more of the same or similar items on their bucket lists.

Accordingly, some embodiments relate to social networks that provide for activity based connections, rather than connection based on pre-existing relationships. An exemplary embodiment may focus on specific age groups. One example embodiment may focus on groups not as ingrained in social networking sites, e.g., 50-60 year olds. People that do not typically use social networking sites may be more likely to use a site with a targeted function to fulfill their bucket list. Another exemplary embodiment may focus on 18-30 year olds. Other exemplary embodiments may focus on other age groups such as 16-17 year olds, 40-50 year olds, and people over 60, etc. Some embodiments may include features that are focused on high school students or college students that might wish to do certain things before graduation.

An exemplary embodiment may allow a large number of different age groups, including allowing persons of any age to use the site. In some cases parents may plan activities for young children or sites may be limited to adults only. Many variations are possible.

An exemplary embodiment allows for the ability to compare different companies for goods and services related to a bucket list item. Comparisons may be quickly compiled for a large number of bucket list items (generally the entire bucket list.) This frees a user from having to search for information on each bucket list item one item at a time.

Various systems and methods described herein may be implemented using a computer. The computer can be a personal computer, laptop computer, desktop computer, mainframe, minicomputer, etc. The systems and methods described herein may be implemented over a network of computers. For example, some embodiments may use the Internet. The Internet is a global system of interconnected computer networks that use the standard Internet protocol suite (TCP/IP) to serve billions of users worldwide. The systems and methods described herein are not limited to implement over the Internet, however. In some embodiments, other systems of networked computers or networked computing devices might be used to set up an e-commerce system.

Further, the systems and methods described herein may be implemented in hardware, software, or a combination of both. Such software may run on processors, such as microprocessors, that may be part of a computer system. Example processors might also include digital logic, programmable logic, analog circuitry, digital circuitry, or other circuitry used to implement a processing function. For example, a processor might be implemented on one or more field programmable gate arrays (FPGAs) or other programmable logic. Processing functions might also be implemented using application specific integrated circuits (ASICs). It will also be understood that any combination of these might be combined to provide for such processing functions.

The communications between computing devices on a network may include wired or wireless communication, terrestrial or satellite based communication, or any other currently known or later developed communication system that might be used in conjunction with the Internet or other computer or computing system based network to provide communication connections between the computers or computing devices. Additionally, it will be understood that combinations of communication systems may be used, such as both terrestrial and satellite based communication.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

For example, various embodiments related to a web based system have been described herein. The systems and methods described herein are not limited to web based embodiments, running on one or more computers, however. For example, the systems and methods described herein might be implemented using any device capable of accessing a web based system, such as handheld mobile computing devices. In other embodiments, an application might run on a computing device, which can communicate with an application on another computing device over a communication channel. The communications channel is not limited to the Internet. For example, an app may be run by a large number of users on a large number of mobile computing devices to implement some or all of the functionality described herein. In this way users of the app may connect and plan to complete bucket list items with other users of the app. It will also be understood that a mobile device based app might interact with web based applications to implement the systems and methods described herein.

What is claimed is:

1. A computer program product comprising:
a non-transitory computer readable medium including instructions causing a computer to perform the following steps:
collecting an activity list from a first user including at least one activity;
collecting an activity list from a second user including at least one activity;
analyzing the activity lists of the first and second users to determine if the activities are the same or similar; and
matching the first user to the second user based on the activity list of each user.

2. The computer program product of claim 1, wherein the first user's activity list includes a plurality of activities and the second user's activity list includes a plurality of activities.

3. The computer program product of claim 2, further comprising instructions implementing a ranking of users based on the number activity list items that match.

4. The computer program product of claim 2, further comprising instructions implementing a ranking of users based on the similarity of activity list items.

5. The computer program product of claim 2, further comprising instructions implementing a ranking of users based on a combination of the number of similar bucket list items and how similar the activity list items are.

6. The computer program product of claim 1, further comprising instructions implementing a live chat between matched users.

7. The computer program product of claim 1, further comprising instructions implementing a user's feedback system to provide feedback on other users or service providers.

8. The computer program product of claim 1, further comprising instructions causing the computer to perform the following steps:
collecting input from users reviewing companies that provide a good or service; and
providing those reviews to users who input the same or a similar activity.

9. The computer program product of claim 1, further comprising instructions implementing a search filter to limit search results to a group having a preselected characteristic.

10. The computer program product of claim 1, wherein the computer program implements a system for matching users over the Internet.

11. A system comprising:
a processor;
a memory, coupled to the processor, the memory including instructions causing the processor to:
collect an activity list from a first user including at least one activity;
collect an activity list from a second user including at least one activity;
analyze the activity lists of the first and second users to determine if the activities are the same or similar; and
match the first user to the second user based on the activity list of each user.

12. The system of claim 11, wherein the first user's activity list includes a plurality of activities and the second user's activity list includes a plurality of activities.

13. The system of claim 12, further comprising instructions implementing a ranking of users based on the number of activity list items that match.

14. The system of claim 12, further comprising instructions implementing a ranking of users based on the similarity of activity list items.

15. The system of claim 12, further comprising instructions implementing a ranking of users based on a combination of the number of similar bucket list items and how similar the activity list items are.

16. The system of claim 11, further comprising instructions implementing a live chat between matched users.

17. The system of claim 11, further comprising instructions implementing a user's feedback system to provide feedback on other users or service providers.

18. The system of claim 11, further comprising instructions causing the computer to perform the following steps:
collecting input from users reviewing companies that provide a good or service; and
providing those reviews to users who input the same or a similar activity.

19. The system of claim 11, further comprising instructions implementing a search filter to limit search results to a group having a preselected characteristic.

20. The system of claim 11, wherein the system is implemented over the Internet.
